(19) United States
(12) Patent Application Publication
(10) Pub. No.: US 2007/0021102 A1
(43) Pub. Date: Jan. 25, 2007

(54) Methods, systems, and storage mediums for providing alternate billing arrangements for communications

(76) Inventor: Stephen Sherman, Alpharetta, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/295,884

(22) Filed: Feb. 9, 2006

Related U.S. Application Data
(60) Provisional application No. 60/701,288, filed on Jul. 21, 2005.

(51) Int. Cl. H04M 11/00

(52) U.S. Cl. 455/408; 455/406

(57) ABSTRACT

A method of cross-network reimbursements for alternate billing arrangements including: receiving a request for an alternate billing arrangement in connection with a communications session from a communications device on a communications network; authorizing the alternate billing arrangement for the communications session; establishing the communications session between the communications device and a receiver; billing an appropriate party for the communications session; and reimbursing an alternative prepaid network for charges incurred during the communications session.

### CROSS REFERENCE TO RELATED APPLICATIONS

This application claims the benefit of U.S. Provisional Patent Application Ser. No. 60/701,288, filed Jul. 21, 2005, which is incorporated herein by reference in its entirety.

### BACKGROUND

The present invention relates generally to providing telecommunication services. More particularly, the present invention relates to providing telecommunication services when predetermined usage limits have been exceeded.

Historically, telecommunication services have been billed on what is essentially a credit basis. Unlimited usage is given to the customer, and payment is made periodically (e.g., monthly) for the services used during the prior time period. Users of the services (also called subscribers) are generally associated with an account. When telecommunication services are provided to the subscriber, the charge for the services are accrued to the subscriber's account. Often, accounts are associated with specific subscription identifiers, such as a telephone number. At the end of any given time period, the subscriber associated with a particular account is billed for the services provided during the past period.

Despite the fact that such services have withstood the test of time, there are a number of disadvantages associated with billing for services in this manner. Since the service is basically a credit based service, those with very poor credit may not be able to obtain such services. Additionally, the service is not anonymous, the customer must be identified and usage may be tracked, for example, under appropriate judicial authorization. Finally, usage is not inherently limited to the customer primarily associated with the account. Other household members, for example, may use the service, incurring significant costs that must be paid by the customer primarily associated with the account, rather than by the actual user.

In response to some of the deficiencies of the above-described billing methods, prepaid services have gained in popularity. In general, prepaid services involve the prepayment of a given amount of money and, in return, receipt of a prepaid identification number. Whenever calls are made, usage costs are decremented against the prepaid amount. While the user must disclose the prepaid identification number before obtaining such services, personal identification is not necessary. Furthermore, when the prepaid amount is depleted, service is terminated, and no further costs can be incurred. In this way, the customer who pays for the prepaid services can control the maximum expenditure by limiting the amount of money that is prepaid.

In prepaid wireless systems, the wireless phone number is dedicated to pre-paid services. This prepaid wireless phone service does not require the dialing of a special number or inputting of a prepaid card number. Rather, when a call is made the network recognizes the calling wireless phone number as one that is associated with a prepaid service. The network then automatically checks the current balance and decrements for usage. When the prepaid balance is depleted, a current call may be terminated, and future calls will not be allowed until the prepaid balance is restored.

Despite the popularity of prepaid services, there remain certain disadvantages in the current implementations. One such disadvantage is that when the prepaid amount is depleted, the phone can no longer be used, except, perhaps, for certain government-mandated emergency calls (e.g., 911). Another disadvantage is that revenue to a wireless carrier may be reduced because users with zero-balance (i.e., no minutes left in their account) may seek alternate communications devices or simply not place calls. Further, if a user runs out of minutes in the middle of a call, the user may not purchase additional minutes and may simply cease the communication. Thus, there is a need for a system to allow a user of wireless communication device to initiate or continue a call even if the user has reached a zero balance.

### SUMMARY

Exemplary embodiments include a method of cross-network reimbursements for alternate billing arrangements including: receiving a request for an alternate billing arrangement in connection with a communications session from a communications device on a communications network; authorizing the alternate billing arrangement for the communications session; establishing the communications session between the communications device and a receiver; billing an appropriate party for the communications session; and reimbursing an alternative prepaid network for charges incurred during the communications session.

Exemplary embodiments also include a method for providing an alternate billing arrangements including: establishing a communications session between a communications device and a receiver; determining an account status corresponding to the communications device; receiving a command from the user indicating that the user wants to utilize alternate billing for the charges associated with the communication session; and initiating a process for alternate billing of the communications session.

Exemplary embodiments further include a computer program product for providing alternate billing arrangements, the computer program product including: a storage medium readable by a processing circuit and storing instructions for execution by the processing circuit for facilitating a method including: receiving a request for an alternate billing arrangement in connection with a communications session from a communications device on a communications network; authorizing the alternate billing arrangement for the communications session; establishing the communications session between the communications device and a receiver; billing an appropriate party for the communications session; and reimbursing an alternative prepaid network for charges incurred during the communications session.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several Figures:

FIG. 1 is a block diagram of a system for providing wireless alternate billing arrangements in exemplary embodiments;

FIG. 2 is a flowchart of a process for providing wireless alternate billing arrangements in exemplary embodiments; and

FIG. 3 is a block diagram of a system for providing cross-network reimbursements for alternate billing arrangements in exemplary embodiments.

### DETAILED DESCRIPTION

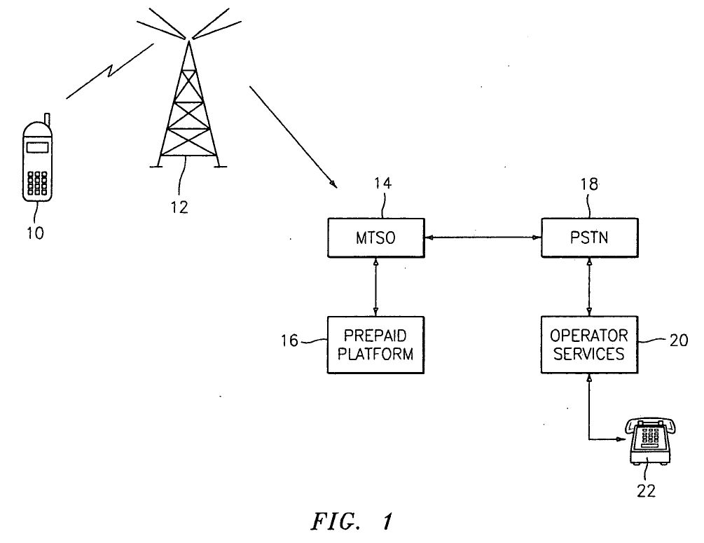

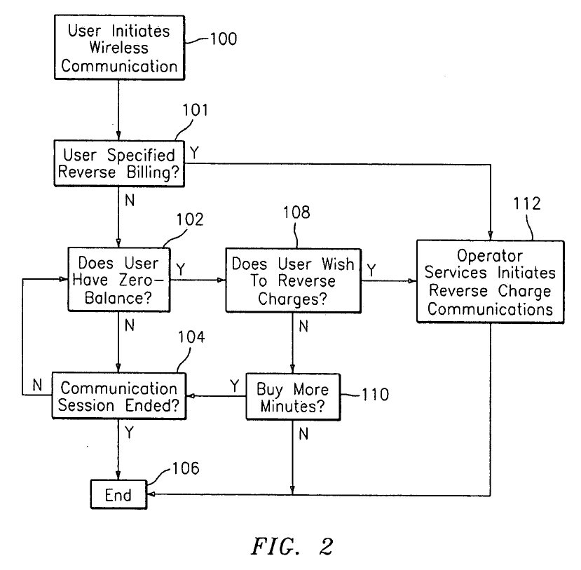

FIG. 1 is a block diagram of a system for providing alternate billing arrangements in exemplary embodiments. Shown in FIG. 1 is a communications device 10 that may be, but is not limited to, a wireless phone, a PDA, VoIP Phone, standard phone, etc. As those skilled in the art will appreciate, the communications device 10 communicates with an access point, such as a base station 12, which in turn communicates with a switch 14. The switch 14 communicates with a prepaid platform 16 which may be maintained by a provider of communications service. The prepaid platform 16 may be connected to the switch 14 in loop back trunking or in signaling configurations, in a manner those skilled in the art will appreciate. The prepaid platform 16 interfaces with the switch to indicate the account status of a user and to initiate prompts to the user in the event that the user has a zero balance. Operation of the system for providing alternate billing arrangements is described in further detail herein with reference to FIG. 2.

In exemplary embodiments, the switch 14 is coupled to communications network 18 through, for example, a central office (CO). As is customary with the communications network, an operator services unit 20 provides services such as initiating alternate billing communications (e.g., collect calls), directory services, etc. The operator services unit 20 can direct communications to a receiver 22. The receiver 22 may be a wireless communications device or a wireline phone. In exemplary embodiments, the operator services unit 20 may query the receiver 22 to determine if the receiver 22 is willing to accept the reverse charges. In other exemplary embodiments, the receiver 22 may have a setting indicative of whether or not the receiver 22 is willing to accept reverse or third party charges.

The setting indicative of whether or not the receiver 22 is willing to accept reverse or third party charges may be either stored locally, e.g., on their communications device 10 or receiver 22, or stored centrally, e.g., in a customer profile stored by the service provider e.g., in the operator services unit 20, which allows the receiver 22 to set rules regarding what (if any) reverse or third party billing the receiver 22 is willing to accept. For example, a user, e.g., a parent, may wish to always allow a specific phone number, e.g., a child's cell phone number, to be able to charge calls to the user's account and may set up a profile to automatically allow such reverse or third party billing. The user may create a profile that contains preferences and/or restrictions for alternate billed communications. Continuing with the above example, the parent may wish to limit several factors of the communications being alternately billed from the child's cell phone including, but not limited to, the total cost of communications used by the child, duration of individual alternate billed communications sessions, or the receiver of the alternate billed communications session.

FIG. 2 is a flowchart of a process for providing alternate charge billing in exemplary embodiments. The process begins at step 100 where a user initiates a communications session from the communications device 10. For example, the user may be placing a telephone call to receiver 22. At step 101, it is determined if the user has requested alternate billing of the communication session. According to an exemplary embodiment, the user may indicate this desire by dialing a feature code (e.g., *00) or dialing 0+ a number to be called. If the user initially requests alternate billing, then flow proceeds to step 112, described in further detail herein. In exemplary embodiments, if the user is attempting to establish a communications session from a prepaid communications device, e.g., a prepaid cellular phone, which has a low usage balance, the user may be alerted of the remaining account balance and prompted to: place the call as dialed, request alternate billing of the communications session; or replenish the prepaid account. The call may still be routed through the prepaid platform 16 to maintain call history with the service provider.

If the user does not initiate reverse or third party billing, at step 102 the prepaid platform 16 is notified by the switch 14 of the request to initiate a communication session. The prepaid platform 16 determines the account status corresponding to the wireless device 10, including whether the user has a zero balance at step 102. If the user does not have a zero balance, the communication session is initiated, and the communications device 10 is placed in communication with the receiver 22 through the communications network 18. In exemplary embodiments, if the user has a low balance, the prepaid platform may announce the user's balance to the user before the communication session is initiated. At step 104, the switch 14 and/or the prepaid platform 16 determines whether the communication session has ended. If so, the process ends at step 106. If not, the communication session continues until the prepaid platform 16 indicates that a zero balance of time has been reached. If a zero balance is reached during the communications session the process proceeds from step 102 to step 108.

Continuing with reference to FIG. 2, at step 108 the user has reached a zero balance, and the prepaid platform 16 initiates a message to the user through the switch 14. The message queries the user whether the user wants to reverse the charges for the communication session with the receiver 22 or charge the communications session to a third party. The message may also include an option to purchase additional minutes from the wireless service provider operating the prepaid platform 16 as shown at step 110. If the user does not elect to reverse charges to the receiver 22 or use third party billing, then the process flows to step 110 where the user is provided the option to buy more minutes. It is understood that the options to reverse charges, use third party billing, and buy more minutes may be offered simultaneously to the user. Thus, the options to reverse charges or use third party billing do not necessarily precede the option to buy more minutes. If the user purchases more minutes at step 110, flow proceeds to step 104 where the communication session continues as described above. If the user does not elect to purchase more minutes at step 110, the communication session is ended at step 106.

If at step 108, the user requests to use alternate billing, then flow proceeds to step 112 where operator services 20 initiates the process for alternate billing arrangements for the communications session to the receiver 22 or a third party. In exemplary embodiments, the operator services unit 20 may query the receiver 22 to determine if the receiver 22 is willing to accept the charges for the call. In other exemplary embodiments, the receiver 22 may have a setting indicative of whether or not the receiver 22 is willing to accept charges for the call. For example, the receiver 22 may have a toll call restriction setting that would prevent the receiver 22 from receiving reverse or third party billed calls. In yet other exemplary embodiments, the operator services may check the account status of the receiver 22 to determine if the receiver 22 is able to accept reverse or third party charges for the communications session. For example, the receiver 22 may have a delinquent or overdue account that could be used in determining if the provider is willing to assume the risk of allowing reverse or third party charges for the communications session. Once the receiver 22 agrees to accept the charges for the communications session, the communications session then proceeds until terminated at step 106.

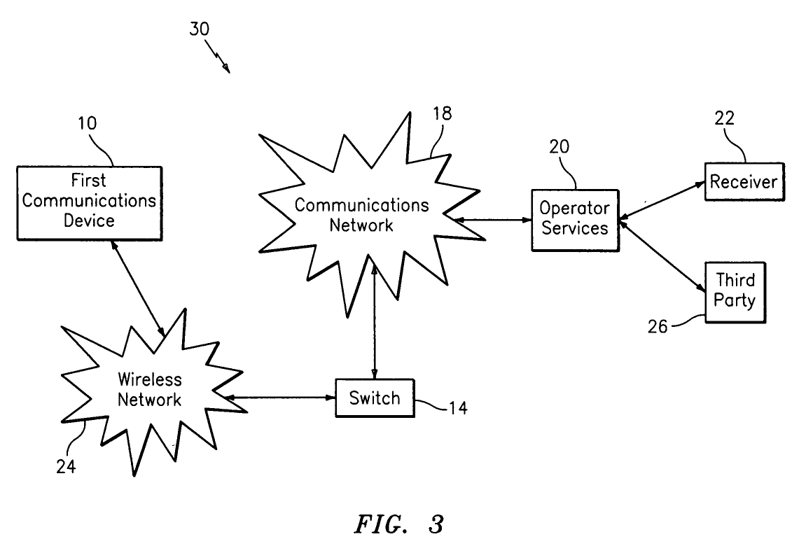

Referring now to FIG. 3, a block diagram of a system for providing cross-network reimbursements for alternate billing arrangements in exemplary embodiments is depicted generally as 30. Exemplary embodiments allow a service provider to increase the use of a communications network, such as a wireless network 24, by providing users with an ability to establish communications even if the user has zero balance of time. In an alternate billing arrangements system, the operator of the communications network 18 may charge either the receiver 22 or a third party 26 for the communication session. The operator of the communications network 18 reimburses the operator of the wireless network 24 for wireless minutes used during the communications session. This increases revenue for both the communications network 18 and wireless network 24 by allowing the establishment of communications sessions that were previously unavailable. For example, a user of a communication device 10 with a zero balance can establish a communications session with the receiver 22, and the operator of the communications network 18 that the receiver 22 belongs to will bill the receiver 22 for the charges associated with the communications session. The operator of the communication network 18 that collected the charge for the communications session will reimburse the wireless provider that handled the communications session for the wireless minutes used. In exemplary embodiments, the receiver 22 is communication device like communication device 10, and the charges for the call are charged to the account of the receiver 22. In alternative exemplary embodiments, the receiver 22 is a prepaid communication device, and the charges for the call are debited from the prepaid balance of the receiver 22.

In exemplary embodiments, the receiver 22 is a wireless communication device, and the operator services 20 presents the receiver 22 with the option to have the reverse charges for the call, in this case minutes, deducted from the receiver's calling plan. For example, the user may initiate a communication session from the communication device 10 to a wireless communication device (in this example, the receiver 22) and indicate a desire to use reverse charges for the communication session. The operator services 20 may then notify the receiver 22 of the incoming reversed charged communications session and present the user with the option of debiting the airtime charges for both ends of the communication session from the wireless plan of the receiver 22. Likewise, a third-party billing system may be utilized in which the charges from the communications session are deducted from the prepaid balance of a third-party.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention.

1. A method of providing cross-network reimbursements for alternate billing arrangements comprising:
receiving a request for an alternate billing arrangement in connection with a communications session from a communications device on a communications network;
authorizing the alternate billing arrangement for the communications session;
establishing the communications session between the communications device and a receiver;
billing an appropriate party for the communications session; and
reimbursing an alternative prepaid network for charges incurred during the communications session

2. The method of claim 1, wherein the communications device is a wireless communications device.

3. The method of claim 1, wherein the appropriate party is at least one of the receiver or a third party.

4. The method of claim 3, wherein the appropriate party includes an account associated with a wireline communications device.

5. A method for providing alternate billing arrangements comprising:
establishing a communications session between a communications device and a receiver;
determining an account status corresponding to the communications device;
receiving a command from the user indicating that the user wants to utilize alternate billing for the charges associated with the communication session; and
initiating a process for alternate billing of the communications session.

6. The method of claim 5, wherein the process for alternate billing the communications session to the receiver comprises determining if the receiver will accept the charges for the communications session.

7. The method of claim 5, wherein the process for alternate billing the communications session to the receiver comprises determining if a third party will accept the charges for the communications session.

8. The method of claim 6, wherein the communications device is a wireless communications device.

9. The method of claim 8, wherein the receiver is another wireless communications device.

10. The method of claim 5, wherein the receiver is a wireline phone.

11. The method of claim 7, wherein the third party is a wireline phone.

12. The method of claim 5 comprising querying a user whether the user wants to utilize alternate billing for the charges for the communication session when the account status indicates a zero balance.

13. A computer program product for providing alternate billing arrangements, the computer program product comprising:
a storage medium readable by a processing circuit and storing instructions for execution by the processing circuit for facilitating a method comprising:
receiving a request for an alternate billing arrangement in connection with a communications session from a commnunications device on a communications network;
authorizing the alternate billing arrangement for the communications session;
establishing the communications session between the communications device and a receiver;
billing an appropriate party for the communications session; and
reimbursing an alternative prepaid network for charges incurred during the communications session.

14. The computer program product of claim 13, wherein the process for alternate billing the communications session to the receiver comprises determining if the receiver will accept the charges for the communications session.

15. The computer program product of claim 13, wherein the process for alternate billing the communications session to the receiver comprises determining if a third party will accept the charges for the communications session.

16. The computer program product of claim 14, wherein the communications device is a wireless communications device.

17. The computer program product of claim 16, wherein the receiver is another wireless communications device.

18. The computer program product of claim 13, wherein the receiver is a wireline phone.

19. The computer program product of claim 15, wherein the third party is a wireline phone.

20. The computer program product of claim 13 comprising querying a user whether the user wants to utilize alternate billing for the charges for the communication session when the account status indicates a zero balance.
